(19) United States
(12) Patent Application Publication
(10) Pub. No.: US 2023/0321602 A1
(43) Pub. Date: Oct. 12, 2023

(54) CATALYTIC FILTERS FOR HYDROGENATION AND EMISSIONS CONTROL

(71) Applicant: UNIFRAX I LLC, Tonawanda, NY (US)

(72) Inventors: Maurice BELISLE, Buffalo, NY (US); Kevin E. SITERS, Cheektowaga, NY (US)

(21) Appl. No.: 17/758,595

(22) PCT Filed: Jun. 10, 2022
(86) PCT No.: PCT/US2022/072869

§ 371 Date: Jul. 11, 2022

Related U.S. Application Data
(60) Provisional application No. 63/209,702, filed on Jun. 11, 2021.

(51) Int. Cl. B01D 53/88; B01D 46/00; B01D 53/86; B01D 46/24; B01D 46/58; B01J 35/06; B01J 35/00; B01J 35/02

(52) U.S. Cl. CPC B01D 53/885; B01D 46/0027; B01D 46/2411; B01D 46/58; B01D 53/8631; B01D 53/864; B01D 53/8687; B01J 35/0026; B01J 35/023; B01J 35/06; B01D 2255/9032; B01D 2255/915; B01D 2255/9202; B01D 2257/404; B01D 2257/502; B01D 2257/708; B01D 2258/0283

(57) ABSTRACT

Catalytic filters are usable in hydrogenation and emissions control processes. The catalytic filters include an open inlet into a hollow body and a closed end thereby forcing fluid or gas through a porous catalytic layer of the filter. The catalytic layer includes inorganic fibers and a catalyst disposed on or incorporated into the fibers.

### CROSS-REFERENCE TO RELATED APPLICATIONS

The present application claims benefit of U.S. Provisional Pat. Application No. 63/209,702 filed Jun. 11, 2021, titled “Catalytic Filters for Hydrogenation and Emissions Control,” which is incorporated herein by reference in its entirety.

### TECHNICAL FIELD

The present disclosure relates to filters including fiber compositions, such as catalytic fiber compositions, for use in industrial processes such as waste gas treatment, hydrogenation, and dehydrogenation. More particularly, the disclosure is related to catalytic filters for hydrogenation and/or emissions control of waste gas streams.

### BACKGROUND

Many manufacturing, industrial and other processes generate waste gases which must be processed to some degree prior to discharge into the environment. For example, electrical power generation is sometimes performed by combusting carbon-based fuels to generate heat, which can be converted into electricity via steam turbines. Similarly, concrete and glass production plants combust fuels to generate heat as part of the production processes. Further, internal combustion engines, which may be used in numerous systems, generate electrical and/or motive power by combusting fuels, such as gasoline or diesel fuel. All of these processes are capable of generating waste gases which must be processed to a degree prior to discharge to the environment.

These waste gases may include carbon monoxide, carbon dioxide, nitrogen oxides, nitrous oxide, ammonia slip, sulfur oxides, hydrogen chloride, hydrogen fluoride, arsenic, boron, lead, mercury, and other harmful gases (e.g., unburned hydrocarbons (“HC”) and volatile organic compounds (“VOC”)) and/or particles. Some or all of these undesirable components of waste gases may be removed by various conventional techniques, many of which involve filters and/or catalyst supports which may physically remove and/or chemically alter the undesirable components prior to discharge to the environment.

Many of the conventional components for conducting these abatement processes suffer from deficiencies. For example, in certain circumstances, ceramic honeycomb filters/catalyst supports are used to remove and/or chemically modify undesirable components found in exhaust gases. These supports may be undesirably heavy, may have low heat tolerance, and/or may be expensive to install and/or operate.

An example of an industrial process which generates waste gases which must be processed prior to discharge into the environment is fluid catalytic cracking (“FCC”). FCC processes are used to convert high molecular weight hydrocarbons to more valuable shorter-chain hydrocarbon groups, such as gasoline or olefins. FCC processes consume large amounts of energy in producing steam, heating the feedstock, and regenerating the catalysts. FCC processes would benefit from lower cost catalytic support materials which may reduce the amount of energy required to catalyze the feedstocks and regenerate the catalyst support materials, as well as materials which would increase the efficiency of processing the waste gases generated by FCC processes.

Other industrial processes may also benefit from improved catalytic support materials, such as: synthesis of ethylene oxide using silver catalyst on alumina; desulfurization of petroleum using molybdenum-cobalt catalyst on alumina; benzene hydrogenation to cyclohexane using nickel/platinum catalysts; production of synthesis gas (“syn gas”) using nickel catalysts; reforming of naphtha using platinum and rhenium catalysts on alumina; making epoxyethane using silver catalysts on alumina; or making sulfuric acid using vanadium catalysts.

An issue that is common across all waste gas treatment devices (reactors) is pressure drop (dP). The dP has to be mitigated when designing the reactor for several reasons. In particular, in a power generation system, high dP will require additional pumps to provide the power needed to move fluid through the reactor/reactor beds or the high dP will yield decreased power output. Further, high dP can result in crushing and compression of catalyst material, which can damage the reactor and decrease efficiency. Additionally, high dP can have negative effects on safety of pressure vessels and upstream systems. In conventional reactors, in order to increase the surface area of the catalyst bed, additional material (e.g., catalyzed spheres or shaped materials) are added, but this undesirably increases dP.

What is needed is light-weight, high temperature resistant, lower cost and/or energy efficient components for waste gas treatment systems and other manufacturing/ industrial processes that do not lead to increased dP. Such product forms may be capable of replacing existing ceramic substrates such as spheres, powders, or monoliths with such compositions/product forms.

### BRIEF DESCRIPTION OF DRAWINGS

Embodiments of the subject matter are disclosed with reference to the accompanying drawings which are for illustrative purposes only. The subject matter is not limited in its application to the details of construction, or the arrangement of the components illustrated in the drawings. Like reference numerals are used to indicate like components, unless otherwise indicated.

FIG. 1A is a diagrammatic view of a filter cartridge according to embodiments of the present disclosure.

FIG. 1B is a diagrammatic cross-section of the filter cartridge of FIG. 1 taken along line B-B.

FIG. 2 is a diagrammatic view of two filter cartridges arranged in series according to embodiments of the present disclosure.

FIG. 3A is a perspective view of a filter structure according to embodiments of the present disclosure.

FIG. 3B is a partial cutaway view of the filter structure of FIG. 4.

FIG. 4 is a partial cutaway perspective view of a reactor including a catalyst bed formed of filter structures according to embodiments of the present disclosure.

FIG. 5 is a perspective view of a filter usable in an emissions control unit according to an embodiment of the present disclosure.

FIG. 6 is a side view of the filter in FIG. 4.

FIG. 7A is a perspective view of a filter usable in an emissions control unit according to an embodiment of the present disclosure.

FIG. 7B is a cross-sectional view of FIG. 7A.

FIG. 8 is a graph showing results from Example 1.

FIG. 9 is a graph showing results from Example 2.

FIG. 10 is a graph showing results from Example 2.

### DETAILED DESCRIPTION

The following descriptions are provided to explain and illustrate embodiments of the present disclosure. The described examples and embodiments should not be construed to limit the present disclosure.

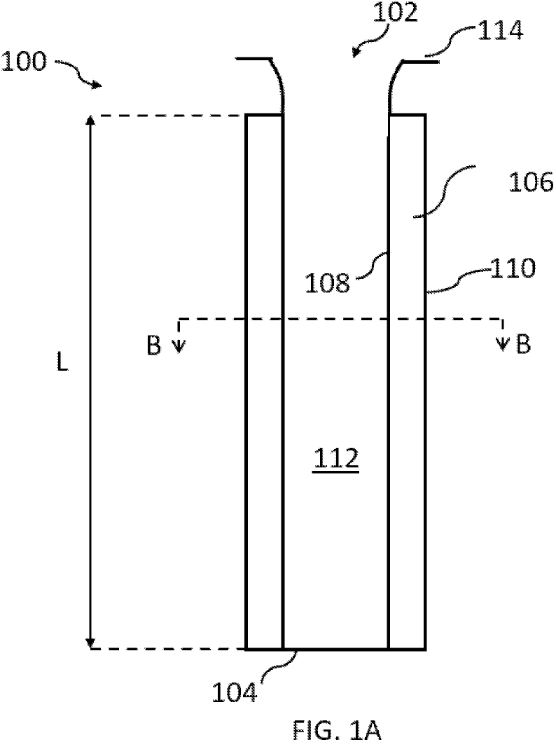

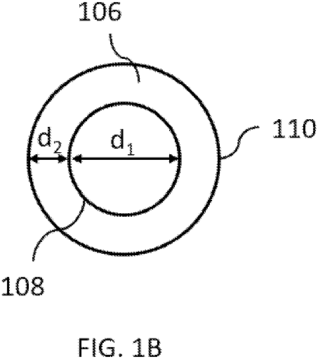

Turning to FIG. 1A, a filter cartridge 100 is depicted having an inlet 102, a closed end 104, and a filter layer 106 positioned between the inlet 102 and the closed end 104. In some embodiments, the filter layer 106 may be contained between an outer permeable layer 110 and an inner permeable layer 108, which together form a hollow body 112 within the filter cartridge 100. In other embodiments, the filter cartridge 100 may include only one of the inner permeable layer 108 or the outer permeable layer 110. In yet other embodiments, the filter cartridge 100 does not include either the inner permeable layer 108 or the outer permeable layer 110. In some embodiments, the inner permeable layer 108 and/or the outer permeable layer 110 comprise a porous screen, wherein the porous screen may comprise, for example, a metal mesh or stainless-steel wire cloth. In some embodiments, the inner permeable layer 108 is a metal mesh having a first mesh size and the outer permeable layer 110 is a metal mesh having a second mesh size. In such embodiments, the first and second mesh sizes may be equal or different. In some embodiments, the first mesh size is smaller than the second mesh size. In other embodiments, the first mesh size is larger than the second mesh size. Each of the inner permeable layer 108 and the outer permeable layer 110 may serve as structural support for the filter cartridge and/or serve to contain the material forming the filter layer 106, which is described in more detail below.

The inlet 102 allows fluid, such as waste gas in need of treatment, to enter an interior of the hollow body 112. As shown in FIG. 1A, the inlet 102 may be a converging inlet. That is, the inlet 102 may include a restriction, wherein an upstream end of the inlet 102 has a larger cross-section area (or diameter) than a downstream end of the inlet 102. In some embodiments, the restriction may have a straight profile (i.e., narrow at a steady rate). In such embodiments, the inlet 102 may include a surface that deviates from a longitudinal axis of the filter cartridge 100 by about 30 degrees, about 10-60 degrees, or about 20-40 degrees. In other embodiments, the restriction may have a curved profile. The curved profile may be convex or concave. In some embodiments, the curved profile is convex with respect to an interior of the inlet 102. In some embodiments, the curved profile has a degree of curvature of about 20 degrees, about 30 degrees, about 10-60 degrees, or about 20-40 degrees. In some embodiments, the inlet 102 includes a venturi tube. In some embodiments, the inlet 102 has a length of about 10-120 mm, about 30-90 mm, or about 60 mm, wherein the restriction may occur over the entire length or a portion thereof.

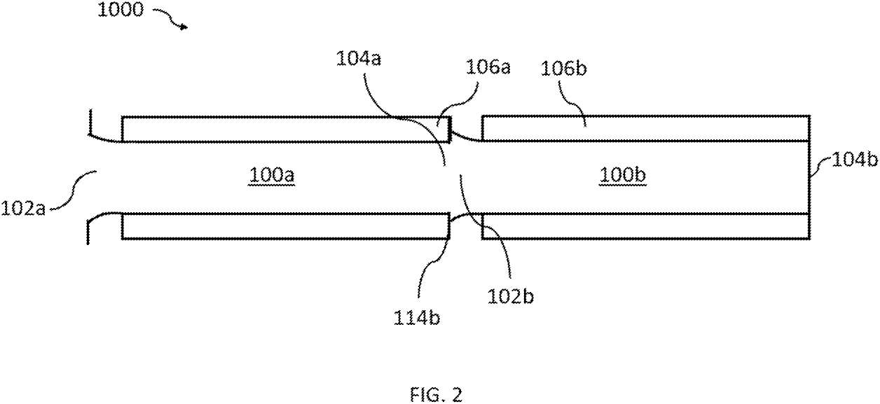

The closed end 104 is positioned opposite the inlet 102 such that fluid flows out of the filter cartridge 100 through side portions of the hollow body 112 between the inlet 102 and the closed end 104 (i.e., through the filter layer 106). In some embodiments, the closed end 104 is a solid sheet, such as a metal end cap. In other embodiments, the closed end 104 may be permeable or semi-permeable and may include a filter material, such as that forming the filter layer 106, optionally including one or more permeable layers, such as the inner and outer permeable layers 108, 110 described herein. In yet other embodiments, the closed end 104 may be sealed by a second filter cartridge, as described in detail below with reference to FIG. 2.

Turning to FIG. 1B, which is a diagrammatic cross-section of FIG. 1A taken along line B-B, the inner permeable layer 108 may be cylindrical and have a diameter d₁ (also referred to herein as the inner diameter of the filter cartridge 100), the filter layer 106 may have a thickness equal to d₂, and the outer permeable layer 110 may be cylindrical and have a diameter of d₁+d₂ (also referred to herein as the outer diameter of the filter cartridge 100). In some embodiments, the filter cartridge 100 may have an outer diameter of about 130 mm, about 135 mm, about 50-200 mm, about 70-180 mm, about 90-160 mm, or about 110-150 mm. In some embodiments, the filter cartridge has an inner diameter (d₁) of about 75-80 mm, about 70-85 mm, about 50-100 mm, or about 40-120 mm. In one or more embodiments, the filter cartridge 100 has a length L of about 1000 mm, about 300-350 mm, about 50-3000 mm, about 100-2000 mm, about 500-1500 mm, about 800-1200 mm, or about 900-1100 mm. In some embodiments, the filter cartridge 100 comprises a flange 114 at one end thereof. The flange 114 may be perforated and may be configured to secure the filter cartridge 100 in place and limit vibration thereof. In some embodiments, the filter cartridge 100 may exclude the flange 114. In some embodiments, the flange 114 may be configured to be affixed to a mounting plate, e.g., in the housing of a reactor.

The filter layer 106 is porous and allows fluid to flow therethrough. The filter layer 106 may be catalyzed in order to aid in treatment of one or more pollutants contained within the fluid (waste gas). The filter layer 106 may include inorganic fibers and a catalyst, such as those described in U.S. Pat. Application Publication No. 20190309455 A1, which is incorporated herein in its entirety. In some embodiments, the fibers have a median diameter of about 1-13 microns, about 4-10 microns, about 4 microns, about 5-9 microns, about 6-8 microns, or about 7 microns. In some embodiments, the catalyst is a platinum group metal. In some embodiments, the catalyst is platinum, rubidium, antimony, copper, silver, palladium, ruthenium, bismuth, zinc, nickel, cobalt, chromium, cerium, titanium, iron, vanadium, gold, manganese, or combinations thereof. In some embodiments, the catalyst is present in an amount of about 0.1-40 wt%, about 1-20 wt%, or about 3-10 wt%, based on a total weight of the fibers and the catalyst.

In some embodiments, the filter layer 106 has a thickness d₂ of about 25 mm, about 10-40 mm, about 15-35 mm, about 20-30 mm, about 55-65 mm, about 50-70 mm, about 40-80 mm, or about 30-100 mm. In one or more embodiments, the filter layer 106 may have a density of about 0.1 g/cc, about 0.05-0.5 g/cc, about 0.075-0.3 g/cc, about 0.09-0.25 g/cc, or about 0.1-0.2 g/cc.

In some embodiments, the filter layer 106 has a variable density. For example, in some embodiments, the density of the filter layer is higher near the inlet 102 and/or near the closed end 104 as compared with a middle portion of the filter layer. By increasing the density at one or both of the ends of the filter layer 106, the filter cartridge 100 may have a tighter seal to minimize or eliminate fluid passing through untreated. In some embodiments, the density of the filter layer 106 may be variable along the length thereof in order to even out fluid flow through the filter layer 106.

Although the filter cartridge 100 is depicted herein as having a cylindrical shape, it is not so limited and may be, e.g., a triangular prism, a square prism, a rectangular prism, an irregular shape, etc. Each filter cartridge 100 may be configured to suit the particular needs of the industrial process in which it is being employed.

Turning to FIG. 2, in some embodiments, a plurality of filter cartridges 100a, 100b...100n may be arranged in series to form a filter structure 1000. In such embodiments, an end 104a of a first filter cartridge 100a opposite the inlet 102a may be “sealed” by a second filter cartridge 100b. That is, the end 104a may be partially or fully open to the second filter cartridge 100b. In such embodiments, the second filter cartridge 100b (or final filter cartridge if more than two filter cartridges are aligned in series) includes a sealed closed end 104b, such as those described above. Accordingly, the overall filter structure 1000 is sealed such that all of the fluid entering the first inlet 102a is forced to pass through the filter layer 106a, 106b of at least one of the filter cartridges 100a, 100b. The first inlet 102a and the second inlet 102b may be as described above with respect to the inlet 102. In some embodiments, the second inlet 102b is straight, i.e., parallel to a longitudinal axis of the second filter cartridge 100b.

In some embodiments, the second filter cartridge 100b includes a flange 114b that is configured to attach to the first filter cartridge 100a. In some embodiments, the first filter cartridge 100a may include a structure proximate the end 104a configured to attach to the flange 114b. For example, the first filter cartridge 100a may include perforations at end 104a that align with perforations of the flange 114b.

In some embodiments, the end 104a may include a filter layer positioned between the first filter cartridge 100a and the inlet 102b of the second filter cartridge 100b. In such embodiments, the filter layer of the end 104a may include components such as the filter layer 106, the inner permeable layer 108, and the outer permeable layer 110 described herein. In some embodiments, the end 104a may be more permeable than the filter layer 106a of the first filter cartridge 100a.

In some embodiments, the filter structure 1000 comprises two filter cartridges 100a and 100b. In some embodiments, the filter structure 1000 comprises at least two filter cartridges 100a, 100b... 100n. Each of the filter cartridges 100a, 100b... 100n may be as described herein with respect to the filter cartridge 100. In some embodiments, the filter structure 1000 includes filter cartridges 100a and 100b that differ in length, inner diameter, outer diameter, filter layer thickness, filter layer composition (fiber type, catalyst type or amount, fiber diameter, fiber length, etc.), filter layer thickness, filter layer density, and/or inlet configuration. In some embodiments, each of the filter cartridges 100a, 100b... 100n is identical except that the last filter cartridge includes a sealed end cap (or an end cap comprising a filter layer) while the other filter cartridges have a permeable end opposite their respective inlet that allows fluid to flow into the inlet of the adjacent downstream filter cartridge.

In some embodiments, the filter structure 1000 may be modular and comprise two or more filter cartridges, wherein the filter cartridges 100a, 100b... 100n may be connected to one another onsite. This design allows for easier installation in applications where space is limited (e.g., in a reactor). The modular design also allows for easy retrofitting of the filter structures 1000 into existing reactors.

In some embodiments, the filter structure 1000 comprises two filter cartridges 100a and 100b connected in series, wherein a flow distribution between the first and second filter cartridges 100a and 100b differs by 1% or less. As used herein, the flow distribution is measured as the volume percentage of fluid that passes through the filter layer 106a versus the filter layer 106b.

In one or more embodiments, filter cartridge 100 (or filter structure 1000) may form a portion of a catalyst bed of a reactor, such as a hydrogenation reactor, wherein fluid (gas and/or liquid) processed through the reactor undergoes catalytic hydrogenation. For example, the fluid may undergo selective hydrogenation of diolefins to avoid gum and green oil formation, conversions of light mercaptans and sulfides into heavier sulfur molecules, and/or conversions of acetylenes and dienes to primarily olefins. A plurality of filter cartridges 100 may be used as the catalyst bed of a reactor, with the number of filter cartridges 100 being determined based on the dimensions of the reactor and the filter cartridges 100.

A conventional tail-end hydrogenation reactor including catalyst beds comprising catalyzed spheres may have the specifications as shown in Table 1 below.

TABLE 1

Conventional Catalyst Bed

| | |
|---|---|
| Bed Length | 3.35 m |
| Bed Diameter | 3.92 m |
| Bed Volume | 40 m³ |
| Mass of Spheres (2-4 mm) | 29110 kg |
| | 29.1 MT |
| Total Support Surface Area | 30,900 m² |
| Gas Linear Velocity (Face Velocity) | 3.9 m/s |
| Bulk Density of Reactor | 0.72 g/cc |
| Space Velocity (GHSV) | 4205 hr⁻¹ |

Conversely, a tail-end hydrogenation reactor comprising catalyst beds comprising filter cartridges 100 described herein may have the specifications as shown in Table 2 below.

TABLE 2

| | | |
|---|---|---|
| Catalyst Bed with Filter Cartridges | | Difference from Conventional Catalyst Bed |
| Fiber Volume | 4.0 m³ | 10X Less |
| Total Mass of Fiber | 400.0 kg | 70X Less |
| Total Mass of Filters | 3.0 MT | 10X Less |
| Total Filter SA | 104,000 m² | 3X More |
| Gas Linear Velocity (Face Velocity) | 0.34 m/s | 12X Less |
| Space Velocity (GHSV) | 42500 hr⁻¹ | 10X More |

As shown above, using the filter cartridges 100 according to the present disclosure allows for vastly increased throughputs, faster flow potential, and better use of existing bed space. The reactor using filter cartridges 100 also consumes less energy and allows for better heat transfer due to the increased surface area. The filter cartridges 100 can be retrofitted into existing reactors and the compact design thereof allows for installation through existing access points. The replacement of a standard fixed bed of pellets, spheres, etc. with the filter cartridge array will increase the surface area of the system resulting in improved yield, while reducing the volume and weight of the catalyst.

Further, the array of the filter cartridges 100 or filter structures 1000 described herein can reduce the overall dP of a reactor bed by increasing the frontal area of the system. Using conventional catalyst beds, additional shaped material would be added to increase the catalyst surface area. If the externals of the reactor are not changed, this addition of catalyst mass would dramatically raise the dP of the system. Conversely, as noted above, the filter cartridges 100 or filter structures 1000 increased frontal surface area, which reduces dP. That is, the increased dP caused by additional surface area of the filter cartridges 100 or filter structures 1000 is offset by the increased frontal surface area thereof such that the overall dP of the catalyst bed can be maintained or lowered.

According to embodiments of the present disclosure, the ratio of surface area to dP in a reactor bed comprising the filter cartridges 100 or filter structures 1000 can be increased by a ratio of 3 or more as compared to conventional reactor beds.

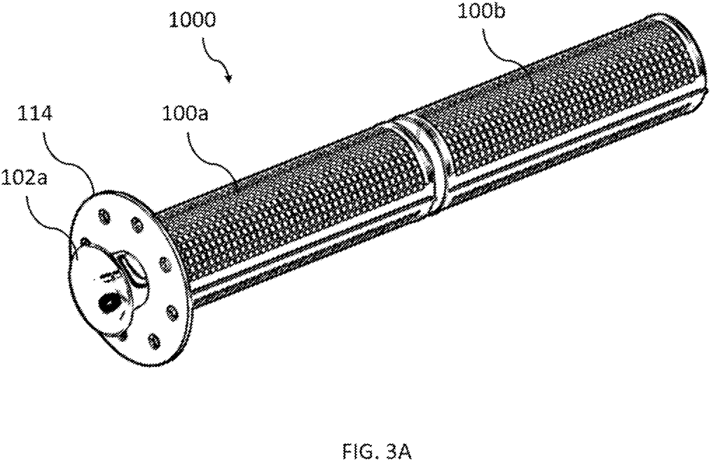

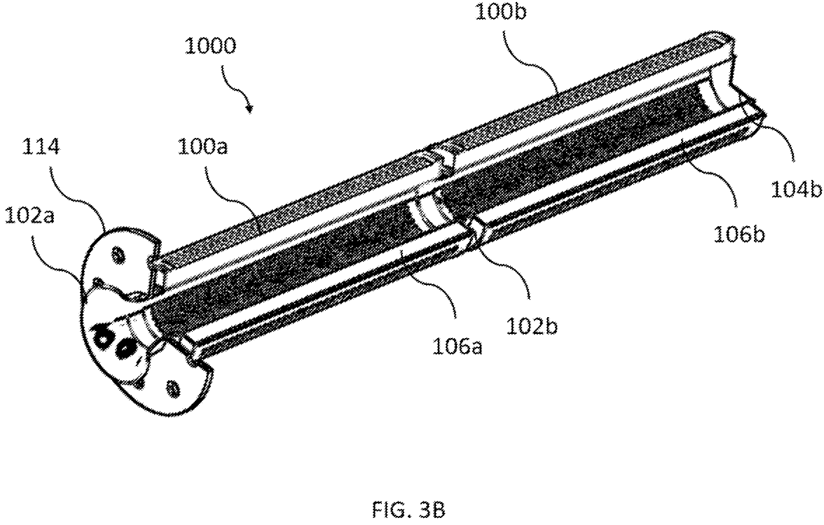

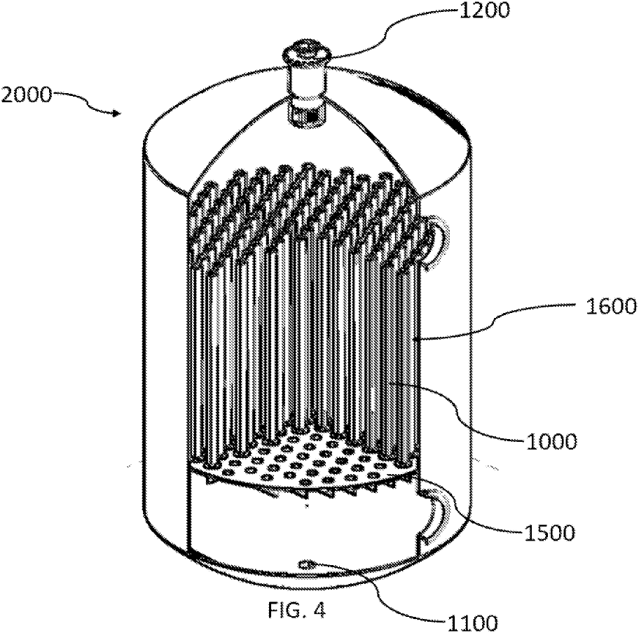

Referring to FIG. 3A, a perspective view of the filter structure 1000 is shown. FIG. 3B is a partial cutaway perspective view of the filter structure depicted in FIG. 3B. FIG. 4 depicts a reactor 2000 comprising a plurality of filter structures 1000 affixed to a mounting plate 1500 to for a catalyst bed 1600. Note that FIG. 4 depicts an incomplete catalyst bed 1600 to show details, whereas, in operation, all of the openings in the mounting plate 1500 would have a corresponding filter structure 1000 affixed thereto. Although the filter structures 1000 are depicted as being affixed above the mounting plate 1500 in FIG. 4, the opposite configuration is also contemplated, wherein the filter structures 1000 may be hung from the mounting plate 1500. In operation, waste gas may flow in either direction through the reactor 2000. That is, in some embodiments, waste gas may be introduced through port 1100 of the reactor 2000 to the inlets 102a of the filter structures 1000 and flow radially outward through the filter layers 106a, 106b and out through port 1200 of the reactor 2000. In other embodiments, the waste gas may enter through port 1200 and be forced radially inward through the filter layers 106a, 106b and exit through the inlets 102a of the filter structures 1000 and out of the reactor through port 1100.

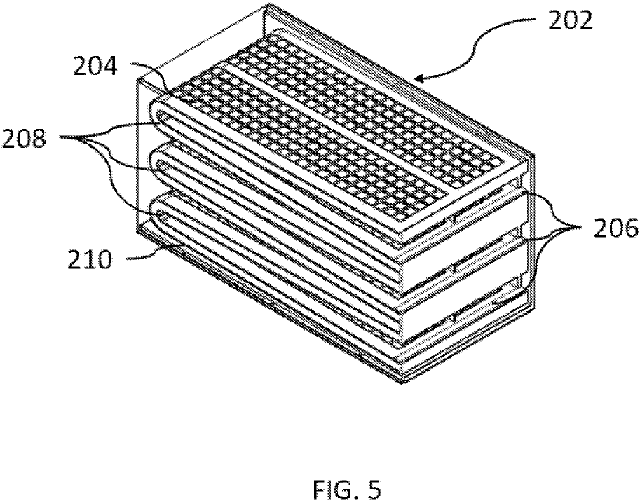

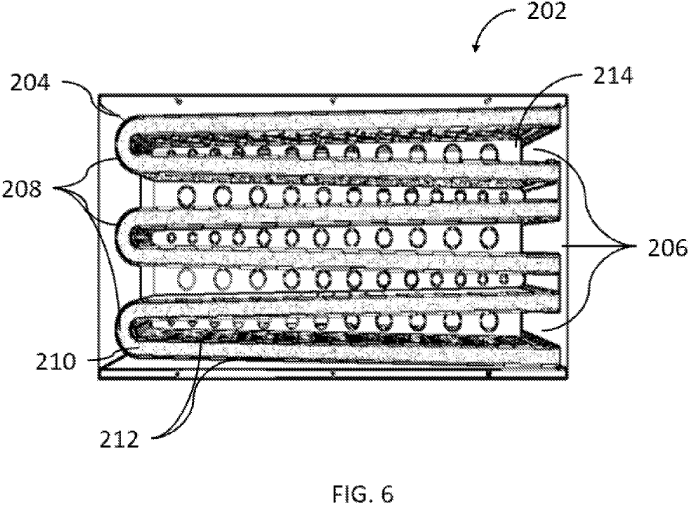

Also disclosed herein is an emissions control unit, which may be used for a wide variety of flue gas treatments, such as CO oxidation, NOₓ reduction, and CO₂ capture. The emissions control unit may include one or more filter modules 202, as shown in FIG. 5 and FIG. 6. Each of the filter modules 202 includes one or more filters 204. In one or more embodiments, the module 202 is a rectangular prism having dimensions of about 150 mm by about 150 mm by about 300 mm, about 50-250 mm by about 50-250 mm by about 100-500 mm, or about 100-200 mm by about 100-200 mm by about 200-400 mm. In some embodiments, the module 202 is shaped and sized to fit existing emissions control units and replace traditional monolith filters.

Each filter 204 in the module 202 includes at least one inlet 206 and at least one closed end 208 opposite the inlet, such that gas flows into the inlet 206 and out through a porous catalytic layer 210. The catalytic layer 210 comprises at least one pleat. That is, the catalytic layer 210 is a folded sheet, which thereby forms the closed end 208 at the fold of the pleat and the inlet 206 opposite the closed end 208. The catalytic layer 210 may be formed of the same materials as the filter layer 106 described above. A thickness of the catalytic layer 210 may be about 9 mm, about 5-40 mm, about 7-30 mm, about 9-20 mm, or about 8-15 mm. A density of the catalytic layer 210 may be about 0.1 g/cc, about 0.05-0.5 g/cc, about 0.075-0.3 g/cc, about 0.09-0.25 g/cc, or about 0.1-0.2 g/cc.

In some embodiments, the filter 204 includes one or more permeable support layers 212. The permeable support layers 212 are porous and may be formed of, e.g., metal screens, which may comprise a metal mesh or fabric. In some embodiments, the filter 204 does not include any permeable support layers 212.

In some embodiments, the filter 204 include one or more support layers 214 positioned between the pleated layers of the catalytic layer 210. The support layers 214 may be shaped to match the dimensions of the pleats to provide rigidity to the filter 204 and maintain a shape of the catalytic layer 210. The support layers 214 may be perforated to allow transverse flow of waste gases within the filter 204.

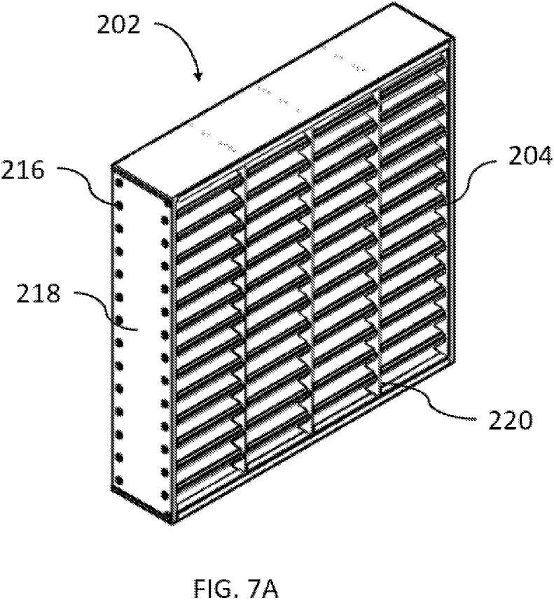

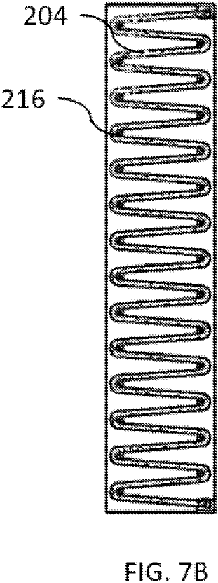

Referring to FIG. 7A, in some embodiments, the module 202 includes a plurality of filters 204 contained within a housing 218, wherein adjacent filters 204 may be separated by dividers 220. In some embodiments, the filters 204 are supported by pins 216. The pins 216 may be positioned at each fold of the pleated catalytic layers, thereby maintaining the structure thereof. The pins 216 may include fasteners (e.g., nuts or washers) to secure the pins 216 to the housing 218 of the module 202. In some embodiments, the pins may be threaded to accommodate the fasteners. FIG. 7B is a cross-section view of the module 202 in FIG. 7A and shows the location of the pins 216 within the catalytic layer 210 structure. In FIGS. 7A and 7B, each filter includes a single continuously pleated catalytic layer 210. In some embodiments, the pleats are about 4-12 inches in height. In such embodiments, the pins 216 may be spaced by a distance equal to the pleat height.

In some embodiments, the module 202 has a depth (measure in a direction from the inlets 206 to the closed ends 208) of about 4-24 inches, about 6-18 inches, about 6-12 inches, about 4 inches, about 6 inches, about 10 inches, about 12 inches, about 14 inches, or about 16 inches. In some embodiments, the module 202 has a width of about 6-40 inches, about 12-40 inches, about 24-36 inches, about 6 inches, about 10 inches, about 18 inches, about 20 inches, about 22 inches, about 24 inches, about 30 inches, about 36 inches, or about 40 inches. In some embodiments, the module 202 has a height of about 6-40 inches, about 12-40 inches, about 24-36 inches, about 6 inches, about 10 inches, about 18 inches, about 20 inches, about 22 inches, about 24 inches, about 30 inches, about 36 inches, or about 40 inches.

A conventional emissions control unit comprising a monolithic catalyst support may have the specifications as shown in Table 3 below.

TABLE 3

Conventional Emissions Control Unit

| | |
|---|---|
| Bed Length | 150 mm |
| Bed Width | 150 mm |
| Bed Depth | 300 mm |
| Monolith Volume | 6,750 cc |
| Mass of Monolith | 0.55 kg |
| Total Monolith Surface Area | 13 m² |
| Specific Surface Area | 2,520 m²/m³ |
| Gas Linear Velocity (Face Velocity) | 1.5 m/s |
| Space Velocity (GHSV) | 17,000 hr⁻¹ |

Conversely, an emissions control unit comprising the module 202 described herein may have the specifications as shown in Table 4 below.

TABLE 4

| | | |
|---|---|---|
| Module Emissions Control Unit | | Difference from Conventional Emissions Control Unit |
| Fiber Volume | 2,000 cc | 3.5X Less |
| Total Mass of Fiber | 0.20 kg | 3X Less |
| Total Mass of Unit | 1.3 kg | Even |
| Total Support Surface Area | 116 m² | 9X More |
| Gas Velocity at the Fiber (Face Velocity) | .14 m/s | 10X Less |
| Space Velocity (GHSV) | 60,400 hr⁻¹ | 3.5X More |

Using the module 202 described herein can maintain a similar or lower incumbent pressure drop (e.g., about 2 mbar or less) while providing the potential for lower CO and VOC oxidation and NOₓ reduction temperatures. Further, active catalysts can be directly applied to the fiber in the catalytic layer 210 without a wash coat (the same is true of filter layer 106). The greatly increased surface area of the support (i.e., fibers in catalytic layer 210) provides more available catalyst thereby improving reaction efficiency.

### EXAMPLES

### Example 1

Computer Fluid Dynamics (CFD) analysis was used to analyze flow distribution and residence time across first and second filter cartridges aligned in series, as in filter structure 1000 shown in FIG. 3. In particular, each of the first and second filter cartridges included a 1″ thick and 328 mm long filter layer having a uniform density of 0.11 g/cc. The inner diameter was 77 mm, the outer diameter was 135 mm, and the filter structure was positioned inside a conduit having a diameter of 190 mm. The operating pressure was 5 bar and the volumetric flow to the inlet was 61.4 m³/hr. Pressure loss of the fiber layer was separately calibrated.

A first test was run with straight inlets for each of the filter cartridges and fibers having a diameter of 7 microns (7-micron fibers). The resulting distribution was calculated as 48.0% in the first filter cartridge and 52% in the second filter cartridge.

A second test was run with straight inlets for each of the filter cartridges and fibers having a diameter of 4 microns (4-micron fibers). The resulting distribution was calculated as 48.9% in the first filter cartridge and 51.1% in the second filter cartridge.

A third test was run with straight inlets for each of the filter cartridges, the 4-micron fibers and a modified metal support structure around the fiber layer comprising less “dead zone” (i.e., a more porous support with a smaller solid, impermeable portion around the peripheries thereof). The resulting distribution was calculated as 49% in the first filter cartridge and 51% in the second filter cartridge.

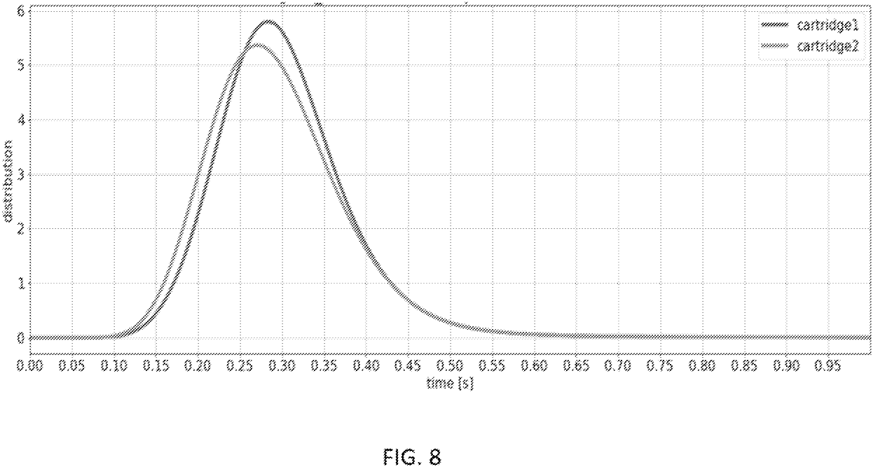

A fourth test was run with the same parameters as the third test but with the addition of a converging inlet for the first filter cartridge. The resulting distribution was calculated as 49.4% in the first filter cartridge and 50.6% in the second filter cartridge. This result is shown in FIG. 8. There was no discernible difference in residence time between fluid in the first cartridge versus fluid in the second cartridge.

In the above tests, it was found that as the difference in distribution increases, significant non-uniformities are observed in the first filter cartridge while flow in the second filter cartridge is significantly more homogenous. As such, the seemingly slight improvements yielded by modifying the inlet configuration and fiber geometry in the second and third tests greatly improved the flow distribution within the first filter cartridge.

There is a very delicate balance between increasing the active surface area in a reactor (resulting in increased yield) without sacrificing any benefit through an increase in dP. Increasing the frontal area of the catalyst bed will reduce the face/ linear/ approach velocity of the fluid to the catalyst bed. In doing so the dP will be lower relative to a bed with a smaller frontal area. Using the filter structure 1000 described herein in a catalyst bed allows for the introduction of additional frontal area. The addition of multiple sections of the filter structure 1000 reduces the dP while still providing a uniform fluid flow distribution between the multiple cartridges 100a, 100b... as the residency time of the fluid traveling in the filter layers 106a, 106b... can be configured to be nearly identical, as shown above.

By minimizing the difference in fluid distribution between the cartridges, the filter structure 1000 can be more efficiently utilized. That is, uneven flow distribution can yield dead zones where catalyst is underutilized. As such, the filter structure 1000 described herein can be effectively use the catalyst while increasing the frontal area and limiting dP.

### Example 2

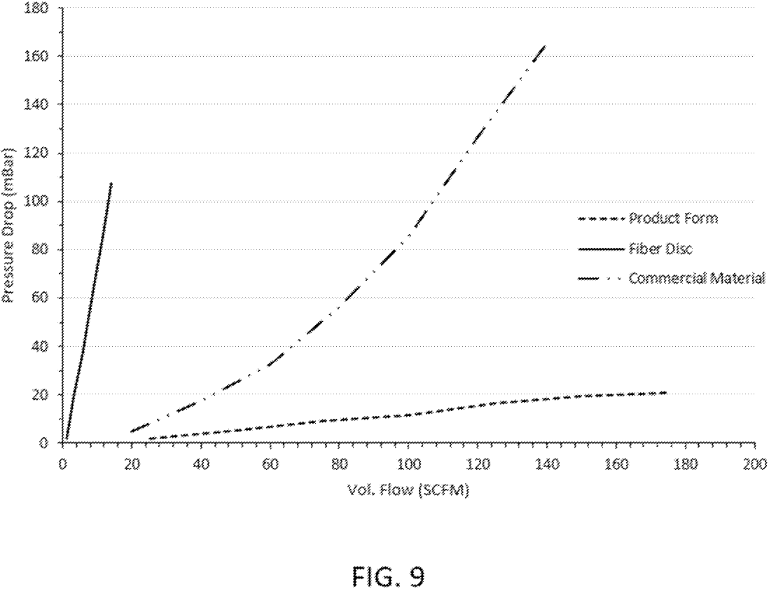

Pressure drop (dP) was determined for three samples arranged in different configurations. One comparative sample was a 4″ diameter disc containing 19 g of fiber and having a thickness of 1″ (“fiber disc”). A second comparative sample was a commercial material comprising 130 g of shaped pellets (“commercial material”). The third configuration (“product form”) was a tube shaped form, as shown in FIG. 2, containing 800 g of fiber. Due to the increased frontal area, the third configuration had a dramatically lower dP, as shown in FIG. 9.

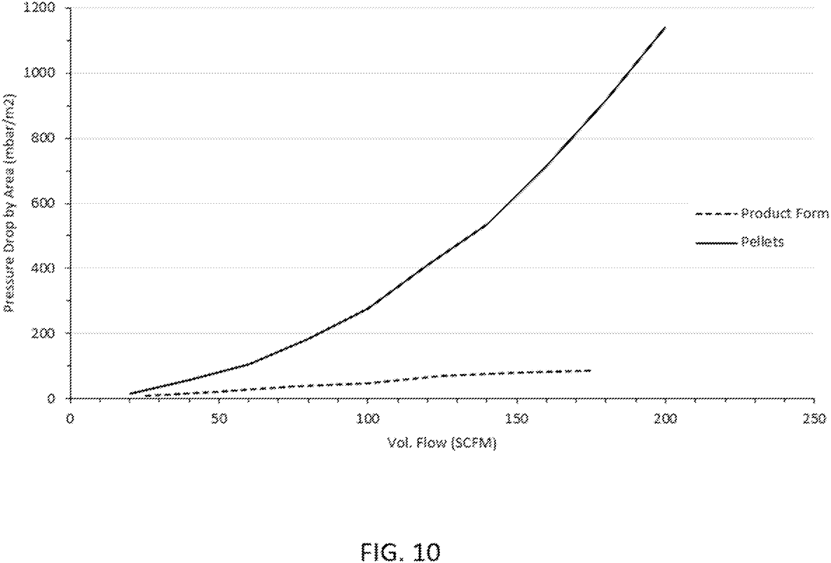

In FIG. 10, the commercial material (referred to as “Pellets”) was compared with the product form on a basis of dP per surface area. As shown, the filter structure (product form) provides a much lower pressure drop per available surface area, thereby enabling a much higher surface area catalyst bed without undesirably increasing dP.

A reactor has been disclosed herein. The reactor includes a housing; one or more catalyst beds disposed within the housing. Each catalyst bed comprises a plurality of hollow filters each comprising an open end, a closed end opposite the open end, and a porous catalytic layer between the open end and the closed end; wherein the porous catalytic layer comprises inorganic fibers and a catalyst. The reactor may include any one or more of the following features:
wherein the porous catalytic layer comprises: a first catalytic portion comprising first inorganic fibers and a first catalyst; a second catalytic portion comprising second inorganic fibers and a second catalyst; and a non-porous connector portion positioned between the first catalytic portion and the second catalytic portion; wherein the first inorganic fibers are the same as or different from the second inorganic fibers and the first catalyst is the same as or different from the second catalyst;
wherein the first catalytic portion differs from the second catalytic portion in fiber composition, catalyst composition, density, thickness, and/or length;
wherein the first catalytic portion has a density of from about 0.05 to about 0.2 g/cm³ and the second catalytic portion has a density of from about 0.05 to about 0.2 g/cm³;
wherein the open end comprises a converging inlet having a cross-sectional area that decreases from a first end thereof to a second end thereof, wherein the second end is closer than the first end to the closed end;
wherein a length of the inlet from the first end to the second end is from about 40 mm to about 80 mm; wherein an inner surface of the inlet is convex and has a degree of curvature of from about 10 to about 40 relative to a longitudinal axis of the hollow filter;
wherein the porous catalytic layer is a hollow cylinder having an inner diameter that is about equal to a diameter of the inlet at the second end;
wherein the porous catalytic layer has a density of from about 0.05 to about 0.2 g/cm³; and wherein the inorganic fibers have a median diameter of from about 4 microns to about 10 microns;
further comprising a third catalytic portion comprising third inorganic fibers and a third catalyst; and a second non-porous connector portion positioned between the second catalytic portion and the third catalytic portion; wherein the third inorganic fibers are the same as or different from the first and/or second inorganic fibers and the third catalyst is the same as or different from the first and/or second catalyst; and/or
wherein the first catalytic portion has a length of from about 300 mm to about 2500 mm; and wherein the second catalytic portion has a length of from about 300 mm to about 2500 mm.

A method of forming a catalyst bed and treating a waste gas has been disclosed herein. The method includes affixing a first hollow filter to a mounting plate, wherein the first hollow filter comprises: a first open end; a second open end opposite the first open end; a first porous catalytic layer disposed between the first open end and the second open end, the first porous catalytic layer comprising first inorganic fibers and a first catalyst; and a flange extending radially outward from the first open end; wherein affixing the first hollow filter comprises securing the flange to the mounting plate. The method further includes affixing a second hollow filter to the first hollow filter to form a filter unit, wherein the second hollow filter comprises: a third open end; a closed end opposite the third open end, the closed end being nonporous; a second porous catalytic layer disposed between the third open end and the closed end, the second porous catalytic layer comprising second inorganic fibers that are the same as or different from the first inorganic fibers and a second catalyst that is the same as or different from the first catalyst; and a second flange extending radially outward from the third open end; wherein affixing the second hollow filter comprises securing the second flange to the second open end of the first hollow filter. The method may include any one or more of the following features:
wherein the first open end comprises a converging inlet having a cross-sectional area that decreases from a first end thereof to a second end thereof, wherein the second end is closer than the first end to the second open end;
wherein the first porous catalytic layer has a density of from about 0.05 to about 0.2 g/cm³ and the second porous catalytic layer has a density of from about 0.05 to about 0.2 g/cm³;
wherein the first hollow filter has a length of from about 300 mm to about 2500 mm; and wherein the second hollow filter has a length of from about 300 mm to about 2500 mm;
further comprising introducing a pressurized waste gas into the first open end to force the waste gas through the first porous catalytic layer and the second porous catalytic layer, wherein the waste gas comprises a pollutant and the first and/or second catalyst is capable of reducing or oxidizing the pollutant;
wherein the filter unit is configured to distribute the waste gas through the first porous catalytic layer and the second catalytic layer such that a volume percentage of waste gas through the first porous catalytic layer is less than 1% different than a volume percentage of waste gas through the second porous catalytic layer; and/or
further comprising installing a plurality of filter units on the mounting plate to form a catalyst bed, each filter unit comprising a first hollow filter and a second hollow filter.

An emissions control module has been disclosed herein. The module includes a housing; and a filter disposed within the housing; wherein the filter comprises a porous filter layer pleated to form at least one open end and at least one closed end opposite the open end; and wherein the porous filter layer comprises inorganic fibers and a catalyst. The module may include any one or more of the following features:
wherein the porous filter layer comprises a plurality of pleats that form a plurality of open ends and a plurality of closed ends opposite the open ends; and/or
wherein the filter comprises a plurality of porous filter layers each pleated to form an open end and a closed end opposite the open end.

Although the present disclosure has been described with reference to embodiments and optional features, modification and variation of the embodiments herein disclosed can be foreseen by those of ordinary skill in the art, and such modifications and variations are considered to be within the scope of the present disclosure. It is also to be understood that the above description is intended to be illustrative and not restrictive. For instance, it is noted that the diameter, length, thickness, and density values described above are illustrative only and can be readily adjusted by one of ordinary skill in the art to fit a wide range of potential reactors and processes. Many alternative embodiments will be apparent to those of ordinary skill in the art upon reviewing the above description. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the disclosure.

What is claimed is:

1. A reactor comprising:
a housing;
one or more catalyst beds disposed within the housing, each catalyst bed comprising:
a plurality of hollow filters each comprising an open end, a closed end opposite the open end, and a porous catalytic layer between the open end and the closed end;
wherein the porous catalytic layer comprises inorganic fibers and a catalyst.

2. The reactor of claim 1, wherein the porous catalytic layer comprises:
a first catalytic portion comprising first inorganic fibers and a first catalyst;
a second catalytic portion comprising second inorganic fibers and a second catalyst; and
a non-porous connector portion positioned between the first catalytic portion and the second catalytic portion;
wherein the first inorganic fibers are the same as or different from the second inorganic fibers and the first catalyst is the same as or different from the second catalyst.

3. The reactor of claim 2, wherein the first catalytic portion differs from the second catalytic portion in fiber composition, catalyst composition, density, thickness, and/or length.

4. The reactor of claim 2, wherein the first catalytic portion has a density of from about 0.05 to about 0.2 g/cm³ and the second catalytic portion has a density of from about 0.05 to about 0.2 g/cm³.

5. The reactor of claim 1, wherein the open end comprises a converging inlet.

6. The reactor of claim 5, wherein a length of the inlet from the first end to the second end is from about 40 mm to about 80 mm; and
wherein an inner surface of the inlet is convex and has a degree of curvature of from about 10 to about 40 relative to a longitudinal axis of the hollow filter.

7. The reactor of claim 5, wherein the porous catalytic layer is a hollow cylinder having an inner diameter that is about equal to a diameter of the inlet at the second end.

8. The reactor of claim 1, wherein the porous catalytic layer has a density of from about 0.05 to about 0.2 g/cm³; and
wherein the inorganic fibers have a median diameter of from about 4 microns to about 7 microns.

9. The reactor of claim 2, further comprising a third catalytic portion comprising third inorganic fibers and a third catalyst; and
a second non-porous connector portion positioned between the second catalytic portion and the third catalytic portion;
wherein the third inorganic fibers are the same as or different from the first and/or second inorganic fibers and the third catalyst is the same as or different from the first and/or second catalyst.

10. The reactor of claim 2, wherein the first catalytic portion has a length of from about 300 mm to about 2500 mm; and
wherein the second catalytic portion has a length of from about 300 mm to about 2500 mm.

11. A method comprising:
affixing a first hollow filter to a mounting plate, wherein the first hollow filter comprises:
a first open end;
a second open end opposite the first open end,
a first porous catalytic layer disposed between the first open end and the second open end, the first porous catalytic layer comprising first inorganic fibers and a first catalyst; and
a flange extending radially outward from the first open end;
wherein affixing the first hollow filter comprises securing the flange to the mounting plate; and
affixing a second hollow filter to the first hollow filter to form a filter unit, wherein the second hollow filter comprises:
a third open end;
a closed end opposite the third open end, the closed end being nonporous;
a second porous catalytic layer disposed between the third open end and the closed end, the second porous catalytic layer comprising second inorganic fibers that are the same as or different from the first inorganic fibers and a second catalyst that is the same as or different from the first catalyst; and
a second flange extending radially outward from the third open end;
wherein affixing the second hollow filter comprises securing the second flange to the second open end of the first hollow filter.

12. The method of claim 11, wherein the first open end comprises a converging inlet.

13. The method of claim 12, wherein the first porous catalytic layer has a density of from about 0.05 to about 0.2 g/cm³ and the second porous catalytic layer has a density of from about 0.05 to about 0.2 g/cm³.

14. The method of claim 13, wherein the first hollow filter has a length of from about 300 mm to about 2500 mm; and
wherein the second hollow filter has a length of from about 300 mm to about 2500 mm.

15. The method of claim 14, further comprising introducing a pressurized waste gas into the first open end to force the waste gas through the first porous catalytic layer and the second porous catalytic layer, wherein the waste gas comprises a pollutant and the first and/or second catalyst is capable of reducing or oxidizing the pollutant.

16. The method of claim 15, wherein the filter unit is configured to distribute the waste gas through the first porous catalytic layer and the second catalytic layer such that a volume percentage of waste gas through the first porous catalytic layer is less than 1% different than a volume percentage of waste gas through the second porous catalytic layer.

17. The method of claim 11, further comprising installing a plurality of filter units on the mounting plate to form a catalyst bed, each filter unit comprising a first hollow filter and a second hollow filter.

18. An emissions control module comprising:
a housing; and
a filter disposed within the housing;
wherein the filter comprises a porous filter layer pleated to form at least one open end and at least one closed end opposite the open end; and
wherein the porous filter layer comprises inorganic fibers and a catalyst.

19. The module of claim 18, wherein the porous filter layer comprises a plurality of pleats that form a plurality of open ends and a plurality of closed ends opposite the open ends.

20. The module of claim 18, wherein the filter comprises a plurality of porous filter layers each pleated to form an open end and a closed end opposite the open end.
